(19) United States
(12) Patent Application Publication
(10) Pub. No.: US 2026/0288988 A1
(43) Pub. Date: Sep. 24, 2026

(54) CONDITIONAL LOG ACCESS

(71) Applicant: International Business Machines Corporation, Armonk, NY (US)

(72) Inventors: Michael E. GILDEIN, Wappingers Falls, NY (US); Michael Terrence COHOON, Fishkill, NY (US); Torin REILLY, Beacon, NY (US); Trent Matthew BALTA, Poughkeepsie, NY (US); Scott SIGALAS, Clintondale, NY (US); Robert MILLER, Jr., Poughkeepsie, NY (US)

(21) Appl. No.: 19/083,061

(22) Filed: Mar. 18, 2025

(51) Int. Cl. G06F 21/62

(52) U.S. Cl. CPC G06F 21/6218

(57) ABSTRACT

Method and apparatus for providing a user with conditional access to a computing system log. Users may request access to a computing system log, but allowing any user unconditional access poses security risks, as the computing system log can contain sensitive information. Embodiments herein relate to a computing system control center using a provided policy to evaluate whether a user should be granted access to a computing system log. The policy can determine a time frame, or certain circumstances, that the user should satisfy to be granted access to the computing system log.

### BACKGROUND

The present invention relates to computing system logs, and more specifically, to accessing computing system logs. A computing system log holds a record of events that occur on a computing system. Logs can capture and store information such as system operations, user actions, errors, warnings, or other system behaviors that monitor performance. Logs can be saved in files or centralized logging systems. Access to information stored in logs can help diagnose problems, analyze patterns, audit, or detect attacks on a computing system. Logs can include timestamps, severity levels of an event, user identifiers, or messages to help understand and respond to certain events. Logs can also contain private information that is not meant to be accessed by all users of a computing system.

### SUMMARY

According to some embodiments, a method including: receiving, at a computing system control center, a request from a user to access a computing system log; reading, at the computing system, a policy defining a plurality of circumstances for which access to the computing system log can be granted and the circumstances for which access should be revoked; determining the request from the user falls under at least one of the plurality of circumstances that would enable the user to be granted access; granting access to the user for a duration of time that the user meets at least one of the defined circumstances; monitoring, by the control center, whether the circumstances for which access should be revoked has occurred; and upon determining access should be revoked by the control system, revoking access to the user to the computing system log.

According to other embodiments, a computer system for generating a data table, the computer system including: one or more computer processors; one or more computer readable storage media; and program instructions stored on the computer readable storage media for execution by at least one of the one or more processors, the program instructions including: receiving, at a computing system control center, a request from a user to access a computing system log; reading, at the computing system, a policy defining a plurality of circumstances for which access to the computing system log can be granted and the circumstances for which access should be revoked; determining the request from the user falls under at least one of the plurality of circumstances that would enable the user to be granted access; granting access to the user for a duration of time that the user meets at least one of the defined circumstances; monitoring, by the control center, whether the circumstances for which access should be revoked has occurred; and upon determining access should be revoked by the control system, revoking access to the user to the computing system log.

According to other embodiments, a computer program product for generating a data table, the computer program product including: a computer-readable storage medium having computer-readable program code embodied therewith, the computer-readable program code executable by one or more computer processors configured to perform operations including: receiving, at a computing system control center, a request from a user to access a computing system log; reading, at the computing system, a policy defining a plurality of circumstances for which access to the computing system log can be granted and the circumstances for which access should be revoked; determining the request from the user falls under at least one of the plurality of circumstances that would enable the user to be granted access; granting access to the user for a duration of time that the user meets at least one of the defined circumstances; monitoring, by the control center, whether the circumstances for which access should be revoked has occurred; and upon determining access should be revoked by the control system, revoking access to the user to the computing system log.

### BRIEF DESCRIPTION OF THE DRAWINGS

FIG. 1 illustrates functional block diagram of a networked environment, in accordance with an example embodiment of the present invention.

FIG. 2 illustrates a control center determining a user's access rights to computing system logs, according to some embodiments.

FIG. 3 illustrates an access agent that communicates with the control center, according to some embodiments.

FIG. 4 illustrates a flow diagram of granting a user conditional access rights, according to some embodiments.

### DETAILED DESCRIPTION

Embodiments herein relate to providing a user with conditional access to a computing system log. Computing system logs herein can include but are not limited to user logs, system logs, operating system logs, and application logs. Users may request access to a computing system log, but allowing any user unconditional access poses security risks, as the computing system log can contain sensitive information. Embodiments herein relate to a computing system control center using a provided policy to dynamically evaluate whether a user should be granted access to a computing system log. The policy can determine a time frame, or certain circumstances, that the user has to satisfy to be granted access to the computing system log.

In some embodiments, the control center oversees a plurality of computing systems. The user activity on each of the plurality of computing systems can be monitored and the policy can be updated according to tasks carried out on the computing systems. A plurality of access agents can be implemented on the computing systems. The access agents can determine whether an event completed by the user relates to a part of the system log that has conditional access rights. The access agent can then either deny or allow the user to have access to the system log after evaluating the tasks. The access agents can then send an update to the control center to identify the tasks that should be blocked or allowed for the user. The policy can be updated by the events that occur on one computing device, and the update can then be sent to the other computing devices that are controlled by the control center. The policy provided to the control center improves the security of the computing systems, as the policy not only defines when access can be granted to a user, but also a duration of time for which access can be granted, meaning the control center can revoke user access.

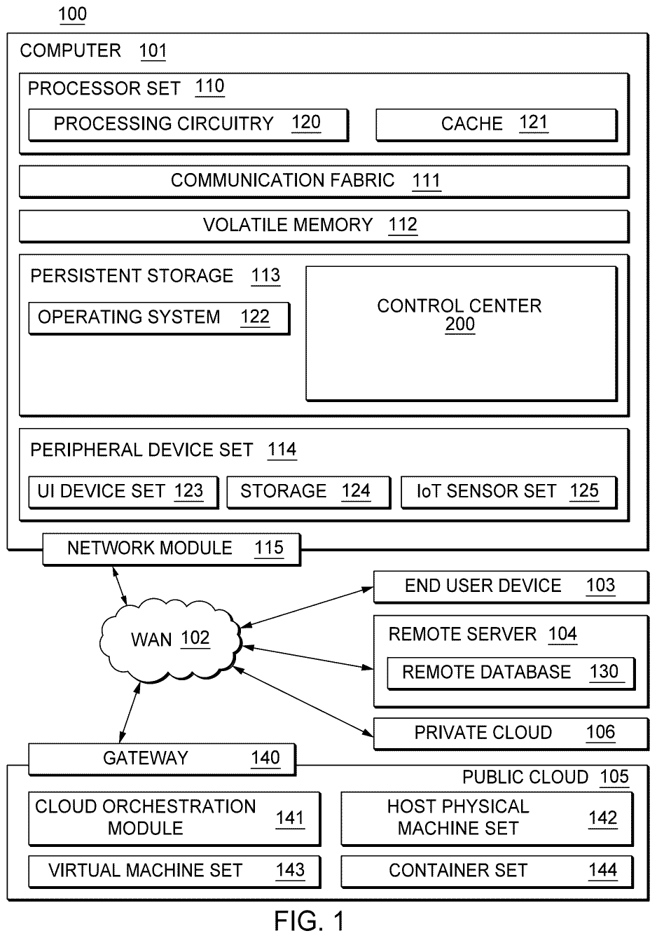

With reference now to FIG. 1

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as control center 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

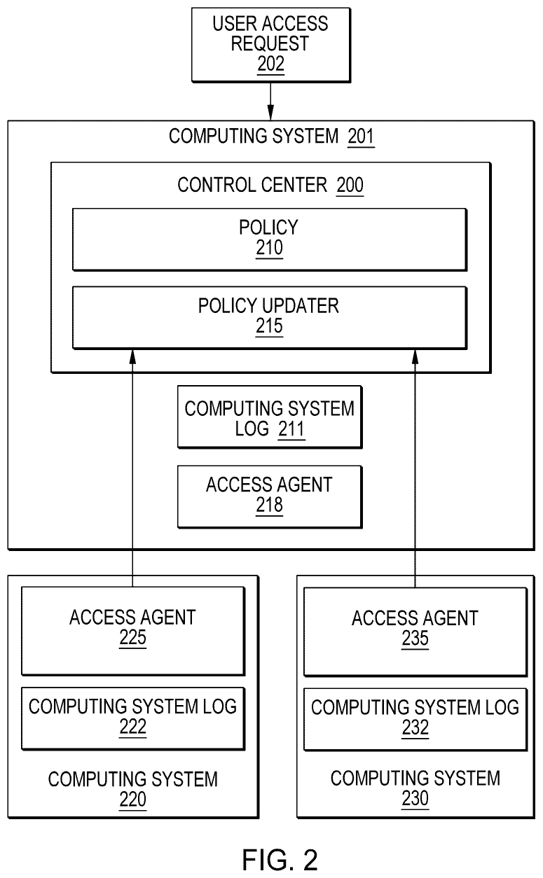

FIG. 2 illustrates the control center 200 and its relationship to a plurality of computing systems, and an implemented policy 210.

The system illustrated shows a computing system 201, a computing system 220, and a computing system 230. In some embodiments, the system does not include the computing system 220 and the computing system 230 (e.g., only the computing system 201). In other embodiments, the system includes the computing system 220 and the computing system 230. In other embodiments, the system includes the computing system 220, the computing system 230, and a plurality of other computing systems.

Computing systems herein can refer to a combination of hardware, software and data that collectively perform computational tasks. Computing systems can contain components such as processors, memory, storage, input/output (I/O) devices, operating systems, applications, firmware, etc. Computing systems can process and store information, allowing users to perform various tasks, such as simple calculations, data analysis, communication, etc. They can be smartphones, laptops, data centers, and supercomputers, among other things,

The computing system 201 contains the control center 200. The control center contains a policy 210, and a policy updater 215. The computing system 201 also has its own computing system log 211.

The policy 210 defines multiple circumstances for which a certain user can access the computing system log 211. The policy 210 can identify certain job identifiers such as job name, account codes, or job classes can be used as access criterion. A job can refer to an entity of work submitted to the system for execution. For example, a script to run a set of programs with a given set of resources and can be a job prioritized against other jobs. The policy 210 can outline the roles and responsibilities of certain users with access to the logs. For example, the policy 210 can determine parts of the computing system log 211 a system administrator can access, a security analyst can access, or a general employee can access, among other types of potential users. Additionally, the policy 210 can contain information regarding a time frame for which users can access the computing system log, so that access can be revoked when the user no longer meets the defined conditions of the policy 210. For example, the length in which the job is executing on the system or while the job output has not been purged, a certain user can be given access rights to a computing system log. However, once the job has finished executing the user's access rights may be revoked.

The control center 200 receives a user access request 202. The user access request 202 is something that indicates to the control enter 200 that a user wishes to gain access to the computing system log 211. For example, the user access request 202 can be a formal request detailing that they would like to access the computing system log 211, or it can be in the form of monitored user activities that imply the user will want access to the computing system log (examples of this are described in more detail below).

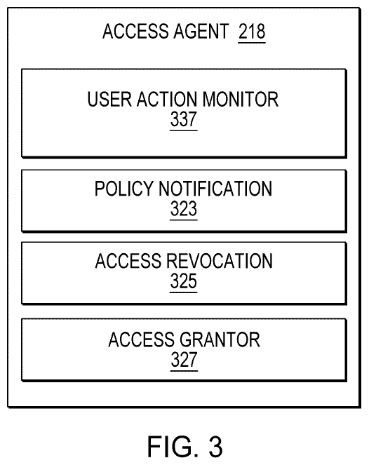

The access agent 218 of the computing system 201 reads the user access request 202 and compares the request 202 to the user's identity and the conditions defined in the policy 210. If the conditions determining the request from the user falls under at least one of the plurality of circumstances defined in the policy, the access agent 218 enables the user to be granted access for a duration of time that the user meets at least one of the defined circumstances. The access agent 218 monitors whether the circumstances for which access should be revoked has occurred. If the access agent 218 detects a circumstance for which the user no longer meets the conditions or circumstances set forth by the policy, the access controller revokes access to the user to the computing system log 211. More details on the access agent 218 are provided in FIG. 3.

In some embodiments, the policy 210 of the control center 200 controls a plurality of computing systems. For example, as illustrated in FIG. 2, the computing system 220 and the computing system 230 are also controlled by the control center 200. The access agent 225 monitors user activity pertaining to the computing system's 220 computing system access log 222, and the access agent 235 monitors user activity pertaining to the computing system's 230 computing system access log 232. For example, a user using the computing system 220 may open a file that indicates that the user is working on a Project X. The access agent 225 may note this, and read from the policy 210 that “users working on Project X can be granted access to computing system logs so long as a particular job on the computing system is executing.” The user could be granted access during execution or during the same login session that a job was submitted, or even before a job output is purged. The user opening the file acts as the user access request 202, and the access agent 225 analyzes the request 202, and then grants access to the computing system log 222. The access agent 225 can then update the policy 210 via the access agent's connection to the policy updater 215. The update can include a change to the policy 210 enabling the user that made the access request 202 in system 220 to automatically gain access to the computing system log 211 and the computing system log 232, among other computing system logs the control center may be connected to.

In some embodiments, the user access request 202 reaches the control center 200 in the form of monitored user activity. The user activity is monitored by the access agents deployed on the multiple computing systems, such as the access agent 225 and the access agent 235. In other embodiments, the user access request 202 is a direct request from a user to view the computing system's log.

The access agent can conditionally grant access to related and/or associated logging data to a calling job, or program, based on what is defied in the policy 210. Access may be granted to logs, logging data, and/or event data based on one or more policy rules and/or rule attributes, including but not limited to caller/callee relationships, temporal conditions, job-specific messages, users, and success/failure rulesets.

Caller/callee relationships can include job groups, process trees, stack call structure, passing token/identifiers (prior art), remote jobs/processes on additional system(s), relationship depth.

Temporal conditions can include pre-defined change windows, or the window that the user's job/program was executing, and/or during dependent job run times. For cumulative or single stream logs, temporal conditions can include allowing temporal access not to the entire log or log file but only to the messages/events during the time, and access to aggregate logging records (ex: SMF records during the window the job was running).

Job-specific messages can include if a log or log message is specific to a job or related job then to allow, or if a log or log message is not specific to a job or related job, then to allow policy to decide based on other rules application or deny entirely

Users can include the concept that certain users may be allowed and/or block listed to enable or disable conditional log access. Additionally, there can be support for different submitting/running users. For example, if User A submits a job which runs as User B, User A now needs access to the resultant logs.

If the user access request 202 is in the form of monitored user activity, and the monitored user activity in itself implements conditional access rights that indicate that the user has certain credentials that align with credentials detailed in the policy 210, the access agent 225 can send this to the policy updater 215. The policy updater 215 can then update the policy accordingly. For example, if the access agent 235 of the computing system 230 monitors a user accessing files from a folder ‘B’ that only users of type ‘A’ have access to, and the policy defines users of type ‘A’ to have access to computing system logs during for the first three hours of the work day, the access agent 235 can send this data to the policy updater 215. The policy updater 215 can update the policy 210 to include the condition “grant users that access folder ‘B’ automatic access to computing system logs.” This update can then be read by the access agent 218 and the access agent 225. The nature of this update provides improvements in efficiency.

FIG. 3 provides details on the access agent 218. The details described in FIG. 3 extend to the access agent 225, the access agent 232, and any other access agents connected to the control center 200.

As discussed in FIG. 2, the access agent 218 can monitor user activity, can trigger the policy 210 to be updated, can block access to the computing system log, and can dynamically grant access to the computing system log on a conditional basis. The components that enable these tasks to be carried out by the access agent 218 include the user action monitor 337, the policy notification 323, the access revocation 325 and the access grantor 327.

The user action monitor 337 is the component that monitors and processes a user's activity on the access agent's 218 computing system. The user action monitor 337 can use real-time alerts to flag user behavior. The user action monitor 337 can capture data such as keystrokes, mouse movements, active applications, visited websites, and file access, among other things. The user action monitor 337 can also track login attempts, changes to a system's settings, network usage, etc.

The data collected by the user action monitor 337 can be compared to access rights detailed in the policy 210. If the user action monitor 337 finds that a certain user action leads to an activity or circumstance detailed by the policy, the policy notification 323 of the access agent 218 is triggered. The policy notification 323 records the flagged user activity from the user action monitor 337 and sends an update to the policy 210 via communication with the policy updater 215. An example of a user event that is tracked by the user action monitor 337 that can trigger an update to the policy 210 is described in FIG. 2.

Once the access agent 218 reads a user request 202, which can be either a formal request or a user action, as described in FIG. 2, the access agent either grants the user conditional access to the computing systems log 211, or denies the user access to the computing system log 211.

The access grantor 327 analyzes the user access request 202 and evaluates the user identity, the request, and the circumstances detailed in the policy 210 that describe user access rights. If at least one of the circumstances detailed in the policy 210 indicates that the identified user is able to access the system log in the manner requested, the access grantor 327 grants the user access to the computing system log or logs controlled by the control center 200. The access grantor 327 then monitors the user after access has been granted to ensure the user still meets the criteria detailed in the policy 210 that enable the user access to the computing system log. For example, if the user is identified as being allowed to access the computing system so long as the user is working on the project ‘X,’ the access grantor 327 monitors the user's identity as a worker on project ‘X’ to grant the user access. Once the access grantor 327 identifies that the user no longer meets at least one of the conditions in the policy 210 that enable the user to have access to the computing system log, the access revocation 325 is triggered. The access revocation 325 revokes the user access after the access grantor 327 determines the time frame for which the user can have access to the system log has expired. In other embodiments, a policy can recognize a user's access rights to a certain log, and rather than filtering the user's access to the log based on the policy, a new log can be generated, where the new log includes the user's access rights. Different subsets of logs can be written to different computing systems based on the policy 210.

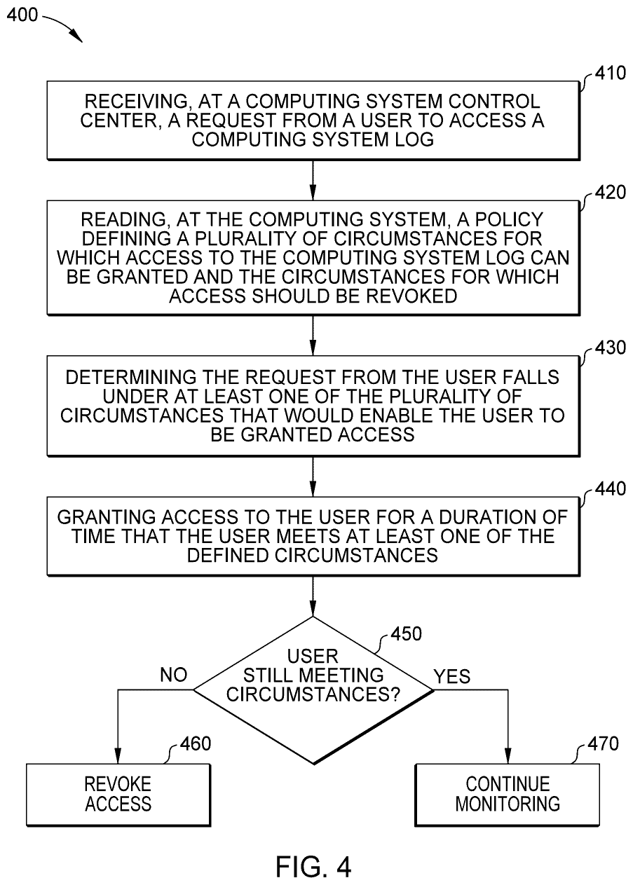

FIG. 4 illustrates the flow diagram 400 of the process of providing a user with conditional access to a computing system log.

At block 410 the control center 200 receives a user access request 202 requesting access to a computing system log.

As mentioned in FIG. 2, the user access request 202 can be in the form of a formal request, or can be monitored activity that implies the user wishes to access the computing system log. For example, a formal request may be the user attempting to directly open the computing system log, and monitored activity can be the user completing a working on completing a certain task ‘A,’ and for the user to complete the task ‘A,’ the user would need to know certain information from the computing system log. The user activity of attempting to complete the task ‘A’can be interpreted as a request to access the computing system log.

At block 420 the access controller 218 of the computing system 200 reads the policy 210. The policy 210 defines a plurality of circumstances for which access to the computing system log can be granted and the circumstances for which access should be revoked. The policy 210 can be a variety of formats that can be interpreted by the control center 200.

At block 430 the access agent 218 determines whether the request from the user falls under at least one of the plurality of circumstances that would enable the user to be granted access. As mentioned in FIG. 3, the access agent 218 uses the action monitor 337 to monitor a user's activity on the access agent's 218 computing system. The user action monitor 337 can use real-time alerts to flag user behavior. The user action monitor 337 can capture data such as keystrokes, mouse movements, active applications, visited websites, and file access, among other things. The user action monitor 337 can also track login attempts, changes to a system's settings, network usage, etc. The data collected by the user action monitor 337 can be compared to access rights detailed in the policy 210.

At block 440 the access grantor 327 grants access to the user for a duration of time that the user meets at least one of the defined circumstances in the policy. As mentioned in FIG. 3, the access grantor 327 analyzes the user access request 202 and evaluates the user identity, the request, and the circumstances detailed in the policy 210 that describe user access rights. If at least one of the circumstances detailed in the policy 210 details that the identified user is able to access the system log in the manner requested, the access grantor 327 grants the user access to the computing system log or logs controlled by the control center 200. The access grantor 327 then monitors the user after access has been granted to ensure the user still meets the criteria detailed in the policy 210 that enable the user access to the computing system log.

At block 450 the access agent 218 monitors the user while access has been granted to ensure the user remains eligible to access the computing system log. This monitoring process is explained in FIG. 3. The access grantor 327 monitors the user while access is granted. If an event is detected that eliminates the user from being categorized as fitting under at least one circumstance detailed in the policy 210, access is revoked. At block 460, the access revocation 325 is triggered to revoke user access. So long as the user remains fitting a circumstance detailed by the policy, the process goes to 470, where the access grantor 327 continues to monitor the user till an event triggers the access revocation 325.

While the foregoing is directed to embodiments of the present invention, other and further embodiments of the invention may be devised without departing from the basic scope thereof, and the scope thereof is determined by the claims that follow.

What is claimed is:

1. A method comprising:
receiving, at a computing system control center, a request from a user to access a computing system log;
reading, at the computing system, a policy defining a plurality of circumstances for which access to the computing system log can be granted and the circumstances for which access should be revoked;
determining the request from the user falls under at least one of the plurality of circumstances that would enable the user to be granted access;
granting access to the user for a duration of time that the user meets at least one of the defined circumstances;
monitoring, by the control center, whether the circumstances for which access should be revoked has occurred; and
upon determining access should be revoked by the control system, revoking access to the user to the computing system log.

2. The method of claim 1, monitoring comprises:
comparing the request to the policy;
monitoring user actions once access is granted;
determining an action the user attempts to complete is not included in the plurality of conditions; and
revoking access.

3. The method of claim 1, wherein the computing system control center oversees a plurality of computing systems, wherein each of the plurality of computing systems comprise at least one computing system log.

4. The method of claim 3, further comprising:
determining, at a first of the plurality of computing systems, a task has been completed by the user;
reading the policy to determine which accesses can be granted to the user based on the task; and
automatically granting the determined accesses at the plurality of computing systems, including the first of the plurality of computing systems.

5. The method of claim 3, further comprising:
receiving an update to the policy from a first of the plurality of computing systems.

6. The method of claim 3, wherein each of the plurality of computing systems contain an access agent, wherein each access agent implements updates made at the computing system control center.

7. The method of claim 6 wherein each access agent monitors events at each of the plurality of computing systems, wherein the monitored events are not yet defined in the policy.

8. The method of claim 1, a duration of time is:
a time the user is working on a project;
an hourly access limit; and
a time a certain computational job is executing on the computing system.

9. A computer system for generating a data table, the computer system comprising:
one or more computer processors;
one or more computer readable storage media; and
program instructions stored on the computer readable storage media for execution by at least one of the one or more processors, the program instructions comprising:
receiving, at a computing system control center, a request from a user to access a computing system log;
reading, at the computing system, a policy defining a plurality of circumstances for which access to the computing system log can be granted and the circumstances for which access should be revoked;
determining the request from the user falls under at least one of the plurality of circumstances that would enable the user to be granted access;
granting access to the user for a duration of time that the user meets at least one of the defined circumstances;
monitoring, by the control center, whether the circumstances for which access should be revoked has occurred; and
upon determining access should be revoked by the control system, revoking access to the user to the computing system log.

10. The system of claim 9, monitoring comprises:
comparing the request to the policy;
monitoring user actions once access is granted;
determining an action the user attempts to complete is not included in the plurality of conditions; and
revoking access.

11. The system of claim 9, wherein the computing system control center oversees a plurality of computing systems, wherein each of the plurality of computing systems comprise at least one computing system log.

12. The system of claim 11, further comprising:
determining, at a first of the plurality of computing systems, a task has been completed by the user;
reading the policy to determine which accesses can be granted to the user based on the task; and
automatically granting the determined accesses at the plurality of computing systems, including the first of the plurality of computing systems.

13. The system of claim 11, further comprising:
receiving an update to the policy from a first of the plurality of computing systems.

14. The system of claim 11, wherein each of the plurality of computing systems contain an access agent, wherein each access agent implements updates made at the computing system control center.

15. The system of claim 14 wherein each access agent monitors events at each of the plurality of computing systems, wherein the monitored events are not yet defined in the policy.

16. The system of claim 9, a duration of time is:
a time the user is working on a project;
an hourly access limit; and
a time a certain computational job is executing on the computing system.

17. A computer program product for generating a data table, the computer program product comprising:
a computer-readable storage medium having computer-readable program code embodied therewith, the computer-readable program code executable by one or more computer processors configured to perform operations comprising:
receiving, at a computing system control center, a request from a user to access a computing system log;
reading, at the computing system, a policy defining a plurality of circumstances for which access to the computing system log can be granted and the circumstances for which access should be revoked;
determining the request from the user falls under at least one of the plurality of circumstances that would enable the user to be granted access;
granting access to the user for a duration of time that the user meets at least one of the defined circumstances;
monitoring, by the control center, whether the circumstances for which access should be revoked has occurred; and
upon determining access should be revoked by the control system, revoking access to the user to the computing system log.

18. The computer program product of claim 17, wherein monitoring comprises:
comparing the request to the policy;
monitoring user actions once access is granted;
determining an action the user attempts to complete is not included in the plurality of conditions; and
revoking access.

19. The computer program product of claim 17, wherein the computing system control center oversees a plurality of computing systems.

20. The computer program product of claim 19, further comprising:
determining, at a first of the plurality of computing systems, a task has been completed by the user;
reading the policy to determine which accesses can be granted to the user based on the task; and
automatically granting the determined accesses at the plurality of computing systems, including the first of the plurality of computing systems.
